(19) United States
(12) Patent Application Publication
(10) Pub. No.: US 2025/0350392 A1
(43) Pub. Date: Nov. 13, 2025

(54) COMMUNICATION APPARATUS, PROCESSING METHOD OF COMMUNICATION APPARATUS, AND STORAGE MEDIUM

(71) Applicant: CANON KABUSHIKI KAISHA, Tokyo (JP)

(72) Inventor: SATORU TSUBOI, Kanagawa (JP)

(21) Appl. No.: 19/182,406

(22) Filed: Apr. 17, 2025

(30) Foreign Application Priority Data
May 8, 2024 (JP) 2024-075970

(51) Int. Cl. H04J 3/06

(52) U.S. Cl. CPC H04J 3/0667

(57) ABSTRACT

Disclosed is a communication apparatus that includes a first counter unit configured to count a first time to be corrected by time synchronization, a second counter unit that counts a second time, a first calculation unit that calculates a difference between the first and second times, a second calculation unit that calculates a first additional value based on the difference, and a limiting unit that assigns a first upper limit to a second additional value if the first additional value is greater than the first upper limit, assigns a first lower limit to the second additional value if the first additional value is less than the first lower limit, and assigns the first additional value to the second additional value in other cases, with the second counter unit counting the second time by adding the second additional value to the second time.

### BACKGROUND

### Field

The present disclosure relates to a communication apparatus, a processing method of the communication apparatus, and a storage medium.

### Description of the Related Art

Nowadays, a technique for synchronizing time between a plurality of devices connected to each other via a network has been used in various fields. A precision time protocol (PTP) has been widely used as a technique for synchronizing time between a plurality of terminals.

In the PTP, terminals respectively operating as a time synchronization source and a time synchronization destination acquire the current time (time stamp) at which the terminals transmit/receive a predetermined packet, and calculate network delay time (one-way transmission time) between the terminals by using the time stamp. The terminal operating as a time synchronization destination calculates a time difference with the terminal operating as a time synchronization source based on the network delay time, and corrects and synchronizes its own time with time of the time synchronization source.

International Publication No. 2020/059137 discusses a technique for changing a counting speed of a time counter which counts the own time based on a time difference between the time of a grand master serving as the time synchronization source and the own time.

Japanese Patent Application Laid-Open No. 2019-176207 discusses a technique for generating a reference signal based on the synchronized time.

In a case where time synchronization is executed by using PTP on a wireless network, network delay time between the terminals calculated by PTP will fluctuate due to fluctuations caused by wireless communication that occurs in the transmission of a packet, which reduces time synchronization accuracy. In a case where a reference signal is generated by using time of a clock with poor synchronization accuracy, fluctuations of time appear in jitters of the reference signal. For this reason, it is assumed that operations performed by a system at a rising edge and a falling edge of the reference signal become unstable.

### SUMMARY

The present disclosure is directed to a technique capable of suppressing a rapid change of time counted by a counter unit, which is to be corrected by time synchronization processing.

According to an aspect of the present disclosure, a communication apparatus includes a first counter unit configured to count a first time; a second counter unit configured to count a second time; a first calculation unit configured to calculate a difference between the first time and the second time; a second calculation unit configured to calculate a first additional value based on the difference; and a limiting unit configured to assign a first upper limit to a second additional value in a case where the first additional value is greater than the first upper limit, assign a first lower limit to the second additional value in a case where the first additional value is less than the first lower limit, and assign the first additional value to the second additional value in other cases, wherein the second counter unit counts the second time by adding the second additional value to the second time.

Further features of the present disclosure will become apparent from the following description of exemplary embodiments with reference to the attached drawings.

### BRIEF DESCRIPTION OF THE DRAWINGS

FIG. 1 is a diagram illustrating a communication system.

FIG. 2 is a block diagram illustrating a configuration of components of a digital camera.

FIG. 3 is a block diagram illustrating a configuration of components of a time management unit.

FIG. 4 is a block diagram illustrating a configuration of components of a follow-up control unit.

FIG. 5 is a diagram illustrating an example of detection of abnormality in an image capturing unit.

FIG. 6 is a diagram illustrating calculation start timings within a follow-up control unit.

FIG. 7 is a flowchart illustrating synchronized image capturing.

FIG. 8 is a flowchart illustrating operations executed by a sub-clock unit.

FIGS. 9A and 9B are a flowchart illustrating operations executed by the follow-up control unit.

FIG. 10 is a flowchart illustrating operations executed by a signal generation unit.

### DESCRIPTION OF THE EMBODIMENTS

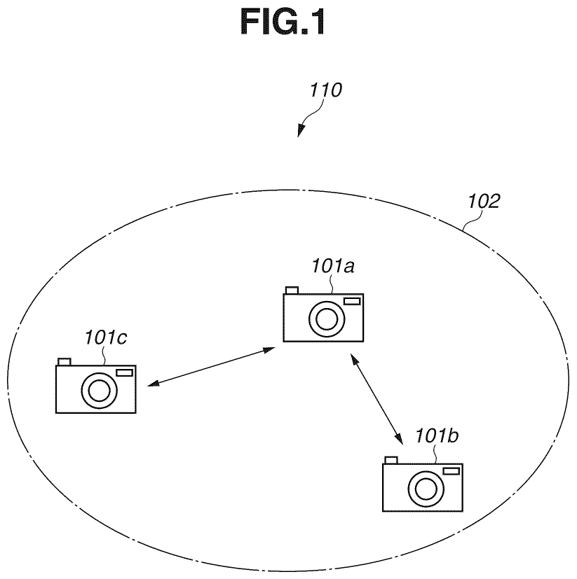

FIG. 1 is a diagram illustrating a communication system 110 according to a first exemplary embodiment. The communication system 110 includes a plurality of digital cameras 101a, 101b, and 101c, and a wireless local area network (LAN) 102.

The digital cameras 101b and 101c participate in the wireless LAN 102 established by the digital camera 101a, with digital camera 101a operating as an access point. The digital camera 101a executes time synchronization using PTP with the digital cameras 101b and 101c as the participants.

In the present exemplary embodiment, the digital camera 101a operates as a time synchronization source (primary terminal) and each of the digital cameras 101b and 101c operates as a time synchronization destination (secondary terminal) in the time synchronization. Hereinafter, each of the digital cameras 101a, 101b, and 101c is described as digital camera 101, when it is not necessary to distinguish one from the other.

The digital cameras 101a to 101c can execute image capturing at the same timing (synchronized image capturing) by generating timing signals for executing image capturing based on the synchronized time.

Although the digital cameras 101 are described as communication apparatuses included in the communication system 110 according to the present exemplary embodiment, other apparatuses such as a smartphone, a personal computer (PC), a video camera, a smart watch, and a drone can also be the communication apparatuses. Although the number of communication apparatuses included in the communication system 110 is three, the number of communication apparatuses is not so limited and may be two, or four or more. The timing signal can also be used for an application other than the image capturing application. For example, the timing signal can also be used for an application for causing a plurality of drones to operate in cooperation with each other.

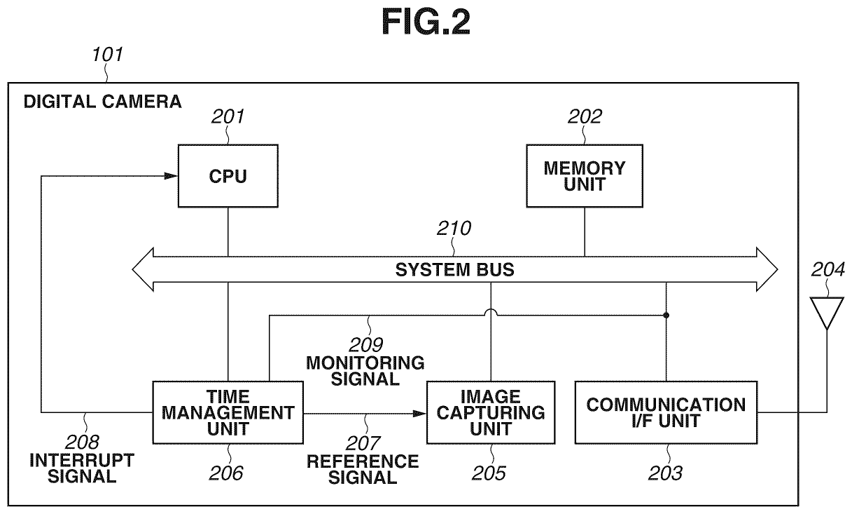

FIG. 2 is a block diagram illustrating a configuration of components of the digital camera 101 in FIG. 1. The digital camera 101 includes a central processing unit (CPU) 201, a memory unit 202, a communication interface (I/F) unit 203, an antenna 204, an image capturing unit 205, a time management unit 206, and a system bus 210.

The CPU 201, the memory unit 202, the communication I/F unit 203, the image capturing unit 205, and the time management unit 206 are connected to the system bus 210. Although each of the functional units is connected to the system bus 210 via one connection line in FIG. 2, each of the functional units may be connected to the system bus 210 via two or more connection lines depending on purposes of use. For example, the communication I/F unit 203 may have two interfaces connected to the system bus 210 in total, i.e., one interface for transmitting data and another interface for accessing a register for controlling the communication I/F unit 203.

The CPU 201 is a processing unit which generally controls the digital camera 101. The CPU 201 also executes time synchronization processing (PTP protocol processing) by transmitting and receiving a PTP packet to/from other digital cameras 101. In a case where the digital camera 101 operates as a secondary terminal, the CPU 201 corrects and synchronizes the time of a clock within the time management unit 206 to the time of a clock within another digital camera 101 operating as a primary terminal in the course of time synchronization processing.

The memory unit 202 is a memory for retaining a program of the CPU 201 and transmitted/received PTP packets. Only one memory unit 202 is illustrated in FIG. 2. However, depending on purposes of use, the digital camera 101 may have a memory divided into a plurality of memory units 202, or a type of memory may be changed.

The communication I/F unit 203 is a functional unit for transmitting and receiving communication packets to/from other digital cameras 101 via the antenna 204. The transmitted/received packets are stored in the memory unit 202.

The image capturing unit 205 is a functional unit which detects a rising edge and a falling edge of the reference signal 207 to capture an image through image capturing processing. Captured image data is retained in the memory unit 202 once. Thereafter, the CPU 201 saves the captured image data in an external medium such as a memory card.

The CPU 201 may execute control to transfer the captured image data to another terminal via the communication I/F unit 203, instead of saving the captured image data in the external medium. The captured image data may be directly saved in the external medium without being retained in the memory unit 202.

The image capturing unit 205 has a mechanism for genlocking to a synchronization signal in order to execute image capturing, and uses the reference signal 207 as a synchronization signal. The image capturing unit 205 may directly use the reference signal 207 as the synchronization signal, or may use the reference signal 207 to generate a synchronization signal to genlock to the generated synchronization signal. The image capturing unit 205 has an error detection mechanism for checking the quality of the reference signal 207 input thereto. In a case where an error is detected, the image capturing unit 205 does not genlock, so that the image capturing unit 205 cannot execute image capturing.

The time management unit 206 includes an internal clock which the CPU 201 uses in the course of time synchronization processing, and generates a reference signal 207 based on time output by the clock. The time management unit 206 generates an interrupt signal 208 for notifying detection of an abnormality. The time management unit 206 has a time stamp function. Through the time stamp function, the time management unit 206 monitors a part of the connection line between the communication I/F unit 203 and the system bus 210 through a monitoring signal 209, and retains time of the internal clock when transfer of a PTP packet is detected.

The system bus 210 connects the function blocks to each other.

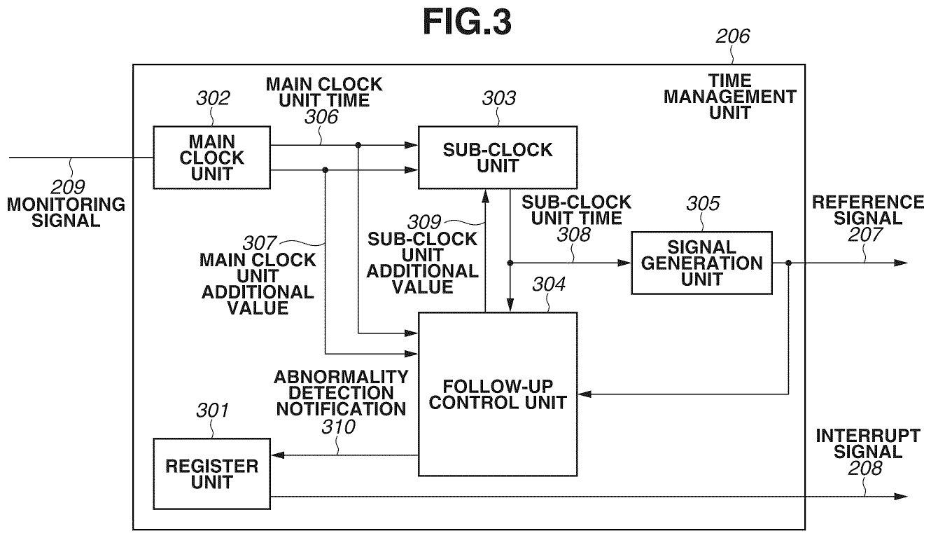

FIG. 3 is a block diagram illustrating a configuration of components of the time management unit 206 in FIG. 2. The time management unit 206 includes a register unit 301, a main clock unit 302, a sub-clock unit 303, a follow-up control unit 304, and a signal generation unit 305.

The register unit 301 is connected to the system bus 210 in FIG. 2, and manages control information about the time management unit 206 set by the CPU 201. The control information includes information about start, stop, and operation modes of the time management unit 206, information about correction of time of the main clock unit 302, information about a limitation range of a correction coefficient used for the calculation executed by the follow-up control unit 304 and a limitation range of a calculated value, and information about a cycle of the reference signal 207 to be output. The register unit 301 generates the interrupt signal 208 when an abnormality detection notification 310 is detected, and a function to notify the CPU 201 that the time management unit 206 executes unexpected operation.

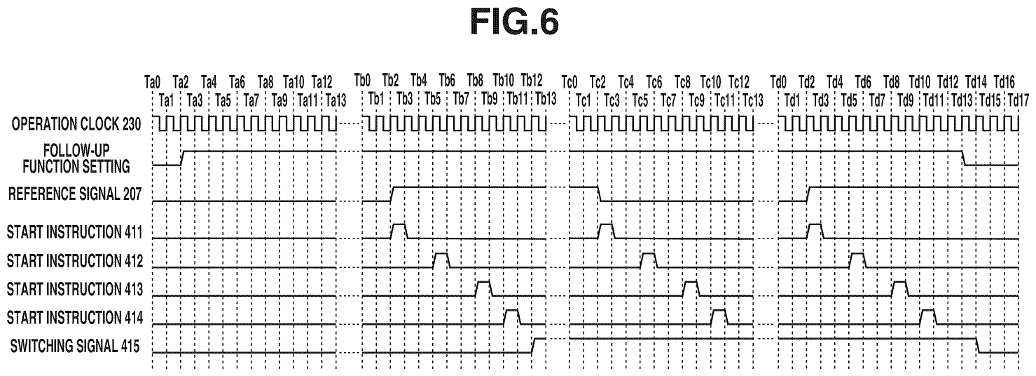

The main clock unit 302 has a counter unit for indicating time. When the main clock unit 302 does not receive an instruction to correct time from the CPU 201 via the register unit 301, the main clock unit 302 has a count-up function to add a value of a main clock unit additional value 307 to time indicated by the counter unit at a rising timing of the operation clock 230 (FIG. 6) of the main clock unit 302.

For example, in a case where the operation is executed in accordance with the operation clock 230 of 100 MHz, the main clock unit 302 retains 10 nanoseconds as an initial setting value for the main clock unit additional value 307, and executes time count-up processing.

The counter unit may indicate time by a plurality of counters instead of one counter. For example, the counter unit may have two counters, i.e., one counter indicating seconds and another counter indicating nanoseconds and sub-nanoseconds.

In the present specification documents, a term sub-nanoseconds is not only used to express 10⁻¹ nanoseconds, but also used to generally express 10⁻² nanoseconds, 10⁻³ nanoseconds, and so on, and a value thereof is not limited to a value in specific figures. When the present exemplary embodiment is to be applied, the number of significant figures of the sub-nanoseconds is increased or decreased depending on the synchronization accuracy required for a system to which the present exemplary embodiment is applied. The operation clock 230 is an operation clock used in the entire time management unit 206.

The CPU 201 can issue instructions to execute three types of time correction via the register unit 301 when time of the main clock unit 302 is to be corrected. The first correction is absolute time correction, by which the time of the main clock unit 302 is overwritten with specified time. The second correction is relative time correction, by which specified time is added to or subtracted from the time of the main clock unit 302. The third correction is frequency correction, by which the main clock unit additional value 307 used for the count-up processing of the main clock unit 302 is updated.

Each of the main clock unit additional value 307 and the sub-clock unit additional value 309 described below has information about nanoseconds and sub-nanoseconds. The CPU 201 reflects the time corrected by PTP on the main clock unit 302 by using the above-described three types of correction.

The main clock unit 302 detects transmission of a PTP packet between the system bus 210 and the communication I/F unit 203 by monitoring the monitoring signal 209. When the main clock unit 302 detects transmission of a PTP packet, the main clock unit 302 retains its own current time and notifies the register unit 301 of its own current time, so that the register unit 301 retains the time of the main clock unit 302.

The CPU 201 can calculate network delay time (one way transmission time) between the digital cameras 101 through PTP by using the time retained by the register unit 301.

The main clock unit 302 continuously outputs the main clock unit time 306 as the current time and the main clock unit additional value 307 used for the count-up processing. Therefore, the sub-clock unit 303 and the follow-up control unit 304 can constantly refer to these two types of information.

The monitoring signal 209 can be a signal operated in accordance with an operation clock different from the operation clock 230. In this case, the main clock unit 302 executes logic for detecting a PTP packet in accordance with that operation clock, and executes other functions in accordance with the operation clock 230. In this case, it is necessary to provide an asynchronous circuit in order to take care of the above-described situation where different operation clocks are used within the time management unit 206.

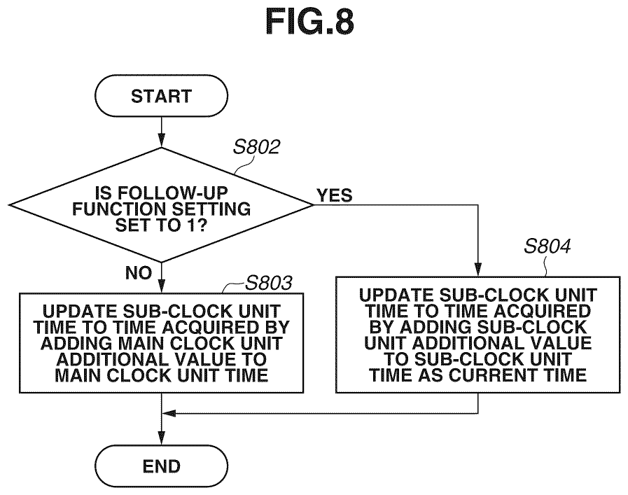

Similar to the main clock unit 302, the sub-clock unit 303 has a counter unit indicating time, and changes the operation according to an operation mode (follow-up function setting) set by the register unit 301. Details are described with reference to FIG. 8. The sub-clock unit 303 continuously outputs the sub-clock unit time 308 as own current time to the outside, and the follow-up control unit 304 can constantly refer to this information.

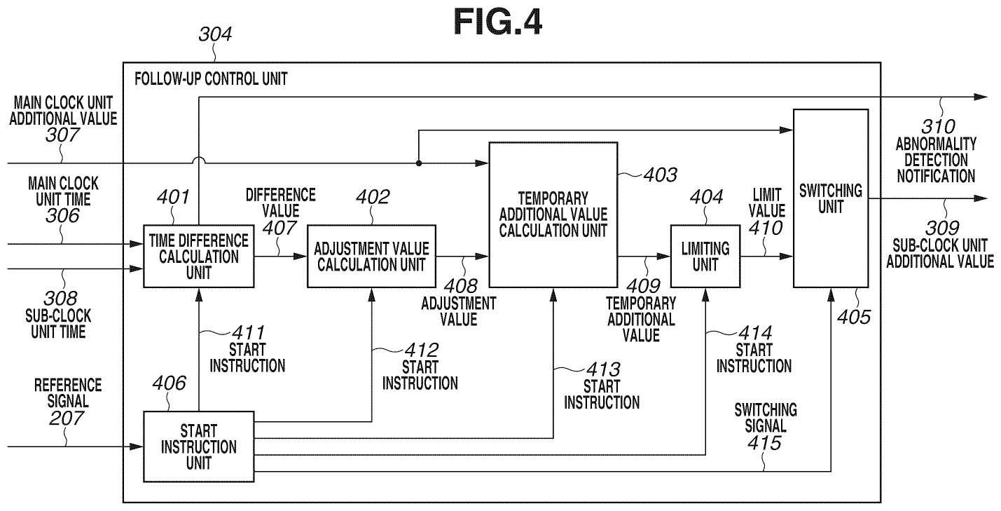

The follow-up control unit 304 calculates a sub-clock unit additional value 309 used by the sub-clock unit 303 by using the main clock unit time 306, the main clock unit additional value 307, and the sub-clock unit time 308. The follow-up control unit 304 uses the operation mode (follow-up function setting) and a correction coefficient set by the register unit 301 when the follow-up control unit 304 executes the above calculation. Details are described with reference to FIG. 4.

The sub-clock unit 303 executes the count-up processing by using the sub-clock unit additional value 309 calculated by the follow-up control unit 304, so that the sub-clock unit 303 can operate to be gradually aligned with the main clock unit 302. In a case where the follow-up function setting is set to 1, the follow-up control unit 304 constantly outputs the sub-clock unit additional value 309 to the outside, so that the sub-clock unit 303 can constantly refer to this information.

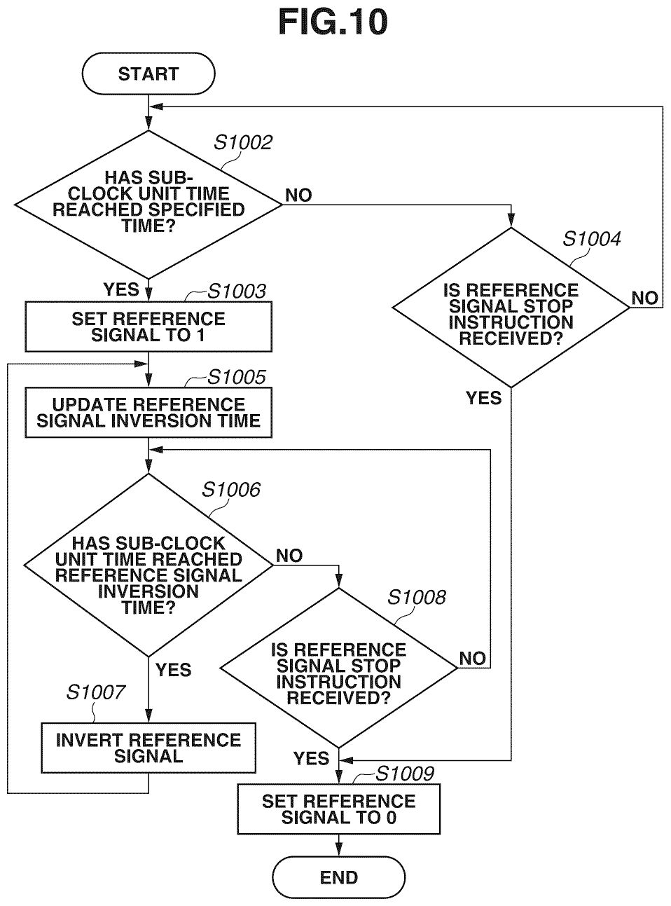

The signal generation unit 305 refers to the sub-clock unit time 308 and cycle information set by the register unit 301, and generates a reference signal 207 toggled in a predetermined cycle (such as 1 Hz or 30 Hz). Operations executed by the signal generation unit 305 (i.e., operations for generating a reference signal 207) are described with reference to FIG. 10.

FIG. 4 is a block diagram illustrating a configuration of components of the follow-up control unit 304 in FIG. 3. The follow-up control unit 304 includes a time difference calculation unit 401, an adjustment value calculation unit 402, a temporary additional value calculation unit 403, a limiting unit 404, a switching unit 405, and a start instruction unit 406.

The time difference calculation unit 401 takes a timing of a start instruction 411 as a starting point to calculate a time difference between the main clock unit time 306 and the sub-clock unit time 308, and outputs the calculated time difference to the adjustment value calculation unit 402 as a difference value 407. In a case where a value of the calculated time difference does not consecutively fall within a specified range a predetermined number of times, the time difference calculation unit 401 outputs the abnormality detection notification 310. Further, the time difference calculation unit 401 forcibly limits the calculated time difference within a range specified by the register unit 301.

The adjustment value calculation unit 402 executes correction value calculation by using the difference value 407 and a correction coefficient retained by the register unit 301 to calculate an adjustment value 408, and outputs the calculated adjustment value 408 to the temporary additional value calculation unit 403. The correction value calculation is started by taking a timing of the start instruction 412 as a starting point. As the examples of the correction value calculation, a method for calculating a correction value to be greater/less than the actual time difference may multiply a Correction Coefficient A by a Difference Value 407, and a correction value may be obtained by multiplying Correction Coefficient A by Difference Value 407, multiplying a Sum of Past Difference Values 407 by Correction Coefficient B, and adding the result of the multiplied values. However, the algorithm used for the correction value calculation is not limited or restricted to the examples. Through the above-described correction value calculation, the follow-up control unit 304 acts like a proportional control (P control) unit or a proportional integral control (PI control) unit. Further, the adjustment value calculation unit 402 forcibly limits a result acquired from the correction value calculation to a value falling within a range specified by the register unit 301.

The temporary additional value calculation unit 403 takes a timing of a start instruction 413 as a starting point to execute calculation for adding the adjustment value 408 to the main clock unit additional value 307. The temporary additional value calculation unit 403 outputs the calculation result to the limiting unit 404 as a temporary additional value 409. When the adjustment value 408 is a negative value, the temporary additional value 409 becomes a value less than the main clock unit additional value 307.

The limiting unit 404 takes a timing of a start instruction 414 as a starting point to execute change processing to make the temporary additional value 409 fall within a range from the set upper limit value to the set lower limit value, and outputs the calculated value as a limit value 410. By controlling a value which the sub-clock unit 303 uses to tick time through the processing executed by the limiting unit 404, it is possible to control a time interval at which a rising edge and a falling edge occur in the reference signal 207 in an actual time.

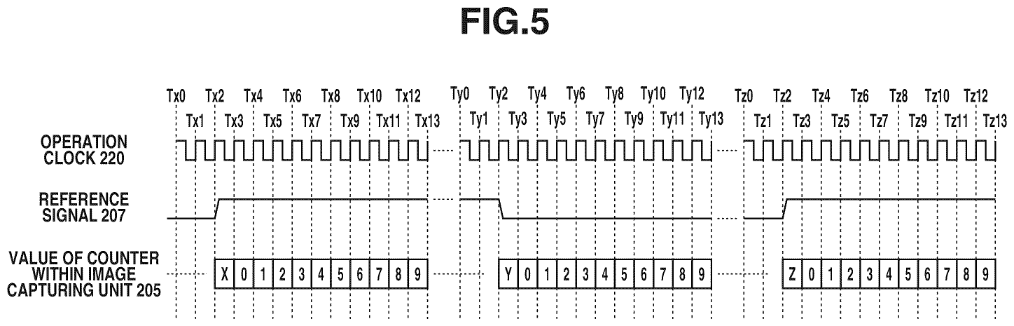

Examples of setting an upper limit value and a lower limit value for limiting the temporary additional value 409, set by the limiting unit 404, is described with reference to FIG. 5. An operation clock 220 in FIG. 5 is a clock signal used by the image capturing unit 205 in FIG. 2. The image capturing unit 205 has a functional block for counting by an internal counter using the operation clock 220. A count value of this counter may be upward and may return to zero when timings of a rising edge and a falling edge occurring in the reference signal 207 generated by the inner part of the time management unit 206 are detected.

Accordingly, in a case where the reference signal 207 input to the image capturing unit 205 is a signal of a specific fixed frequency, counter values X, Y, and Z within the image capturing unit 205 in FIG. 5 indicate the same value, and the counter values return to zero in the next cycle.

The error detection mechanism included in the image capturing unit 205 executes error determination based on the counter values X, Y, and Z. In other words, the image capturing unit 205 determines the signal quality of the reference signal 207 input thereto based on whether a cycle of the reference signal 207 falls within a predetermined range. Herein, a cycle of the reference signal 207 is assumed to be 1 Hz, and the error determination is executed by using allowable lag time of 1 ms per half cycle as a reference. Because a half cycle of 1 Hz is 500 ms, the half cycle determined as normal is a value falling within a range of 499 ms to 501 ms.

When a frequency of the operation clock 220 is 100 MHZ (when a cycle is 10 ns), a value of the counter falling within a range of 49,900,000-1 to 50,100,000-1 is a value of a half cycle falling within a normal range. The reference signal 207 needs to have a rising edge or a falling edge at a value falling within the above-described range.

A timing for toggling the reference signal 207 is managed by time of the sub-clock unit 303 counted up by the sub-clock unit additional value 309. A range of the sub-clock unit additional value 309 may be set in such a way that a counter value naturally falls within a range of 49,900,000-1 to 50,100,000-1 when the sub-clock unit additional value 309 falls within a predetermined range.

Specifically, with respect to the frequency described in the above example, the sub-clock unit 303 only has to tick exactly 500 ms when the operation clock 220 is output 50,000,000 times. The sub-clock unit 303 only has to tick exactly 500 ms when the operation clock 220 is output 49, 900,000 times or 50,100,000 times.

The half cycle of the reference signal 207 is 0.998 times (49,900,000=50,000,000=0.998) or 1.002 times (50,100,000=50,000,000=1.002) the number of times the operation clock 220 is output.

In a case where the time management unit 206 generates the reference signal 207 in a state where the operation clock 220 is 1 GHz and the sub-clock unit additional value 309 is 1 ns, the clock ticks exactly 500 ms when the operation clock 220 is output 500,000,000 times.

In a case where the sub-clock unit additional value 309 is 1/1.002 times, i.e., 9.98003992 ns, a rising edge or a falling edge does not occur in the reference signal 207 when the operation clock 220 is output 500,000,000 times because the clock ticks only 499,001,996 ns.

In a case where the sub-clock unit additional value 309 is 9.98003992 ns, the sub-clock unit 303 ticks exactly 500 ms when the operation clock 220 is output 501,000,000 times, so that a rising edge or a falling edge occurs in the reference signal 207.

If the operation clock 230 (FIG. 6) of the time management unit 206 and the operation clock 220 of the image capturing unit 205 are generated from the same quartz crystal, a period for 500,100,000 times of the operation clock 230 and a period for 50,100,000 times of the operation clock 220 become equivalent actual time in terms of the frequency ratio.

Similarly, in a case where the sub-clock unit additional value 309 is set to 1/0.998 times, i.e., 10.02004008 ns, the sub-clock unit 303 ticks exactly 500 ms when the operation clock 220 is output 499,000,000 times, so that a rising edge or a falling edge occurs in the reference signal 207.

To summarize the above-described example, for the image capturing unit 205 to operate normally, the sub-clock unit additional value 309 has to be changed within a range of 9.98003992 ns to 10.02004008 ns. In a case where synchronized image capturing is to be executed, an upper limit value and a lower limit value for limiting a temporary additional value 409 used by the limiting unit 404 are set to the above-described values. Naturally, these values may be set with margins, with consideration for jitter components included in a quartz crystal of a clock.

When a half cycle of the reference signal 207 is T sec, allowable lag time per half cycle is X sec, and an operation clock cycle of the time management unit 206 is N, a setting value Y of the sub-clock unit additional value 309 falls within a range of Equation (1):

$$\frac{N}{\frac{T + X}{T}} \leq Y \leq \frac{N}{\frac{T - X}{T}} \qquad ( 1 )$$

Returning to the descriptions with reference to FIG. 4, the switching unit 405 selects any one of the main clock unit additional value 307 and the limit value 410 depending on the switching signal 415, and outputs the selected value as the sub-clock unit additional value 309. The switching unit 405 outputs the main clock unit additional value 307 as the sub-clock unit additional value 309 when the switching signal 415 is 0, and outputs the limit value 410 as the sub-clock unit additional value 309 when the switching signal 415 is 1.

When the start instruction unit 406 detects the edge of the reference signal 207, the start instruction unit 406 outputs a start instruction 411, a start instruction 412, a start instruction 413, a start instruction 414, and a switching signal 415 to the respective calculation blocks at predetermined time intervals. Herein, a relationship between these signals generated by the start instruction unit 406 is described with reference to FIG. 6.

FIG. 6 illustrates an example of a timing of starting calculation within the follow-up control unit 304 in FIG. 4, and an operation clock 230 in FIG. 6 represents a clock signal supplied to the switching unit 405.

The switching unit 405 outputs all signals at 0 until the CPU 201 sets the follow-up function setting retained in the register unit 301 to 1 (i.e., Ta3 in FIG. 6).

When the CPU 201 sets the follow-up function setting to 1, the follow-up control unit 304 is enabled and starts operating. In this state, the start instruction unit 406 continuously outputs the switching signal 415 at 0.

When a first rise occurs (at Tb3 in FIG. 6) after the CPU 201 sets a cycle of the reference signal 207 to be generated, the start instruction unit 406 sets the start instruction 411 to 1 to cause the time difference calculation unit 401 to start calculation.

The start instruction unit 406 sets the start instruction 412 to 1 at a timing after three cycles (Tb6 in FIG. 6) to cause the adjustment value calculation unit 402 to start calculation. Similarly, the start instruction unit 406 respectively sets the start instruction 413 and the start instruction 414 to 1 at timings of Tb9 and Tb11 in FIG. 6 to cause the temporary additional value calculation unit 403 and the limiting unit 404 to start calculation. The start instruction unit 406 sets the switching signal 415 to 1 at a timing Tb12.

In this example, although the start instructions 411 and 412 are output with a time difference of three cycles, the time difference does not always have to be three cycles. A time difference of any interval may be set depending on the number of cycles necessary for the time difference calculation unit 401 to complete the entire calculation. The algorithm for the time difference calculation unit 401 is uniquely determined at a design phase, so that a cycle interval may be determined accordingly.

In FIG. 6, the interval between the start instructions 411 and 412 may be designed and calculated by a multi-cycle method or a pipeline stage method which divides the interval into stages. For example, time of the main clock unit time 306 and time of the sub-clock unit time 308 are retained at a timing Tb3, a time difference is calculated at a timing Tb4, and the time difference is limited to a value within a predetermined range at a timing Tb5.

An interval between the start instructions 412 and 413 (Tb6 to Tb9) and an interval between the start instructions 413 and 414 (Tb9 to Tb11) may similarly be adjusted depending on time (or pipeline stages) necessary to execute calculation by the adjustment value calculation unit 402 and the temporary additional value calculation unit 403.

The same can also be said for an interval between the start instruction 414 and the switching signal 415 (Tb11 to Tb13).

These intervals can be the same unless the algorithms of the calculation executed by respective processing units are changed. In a case where the algorithm is changed depending on a condition, the interval may also be changed dynamically according to the change.

Every time an edge occurs in the reference signal 207 after the follow-up function setting is set to 1, the start instructions 411 to 414 are periodically set to 1, so that calculation is executed by the respective calculation blocks. After the switching unit 405 sets the switching signal 415 to 1, the switching unit 405 continuously outputs the switching signal 415 at 1 in a state where the follow-up function setting is set to 1, and brings back the setting of the switching signal 415 to 0 when the follow-up function setting is set to 0.

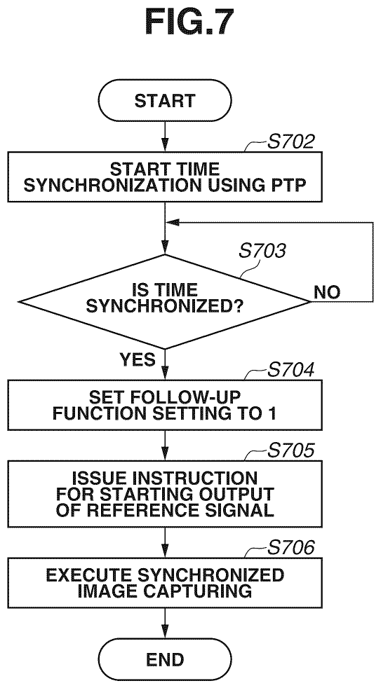

FIG. 7 is a flowchart illustrating a processing method executed by each of the digital cameras 101. Synchronized image capturing executed by the digital cameras 101 is described with reference to FIG. 7. The processing illustrated in the flowchart in FIG. 7 starts in a state where a power source of the digital camera 101 is ON.

In step S702, the CPU 201 starts executing time synchronization processing using PTP. As described above, the digital camera 101a starts executing the processing using PTP as a time synchronization source of time synchronization, whereas the digital cameras 101b and 101c start executing the processing using PTP as time synchronization destinations.

In step S703, the CPU 201 determines whether a time difference of time synchronized by the time synchronization using PTP falls within a predetermined range. In a case where the time difference falls within a predetermined range (YES in step S703), the processing proceeds to step S704. In a case where the time difference does not fall within a predetermined range (NO in step S703), the processing returns to step S703. The CPU 201 continuously executes time synchronization processing even if the processing proceeds to step S704.

In step S704, the CPU 201 sets the follow-up function setting of the time management unit 206 to 1. Then, the processing proceeds to step S705.

In step S705, the CPU 201 instructs the time management unit 206 to start outputting the reference signal 207. At this time, the CPU 201 instructs the same settings of the start time and the frequency (cycle) of the reference signal 207 to each of the digital cameras 101. After the instruction for starting output of the reference signal 207 is issued, the processing proceeds to step S706.

In step S706, the image capturing unit 205 executes synchronized image capturing by using the generated reference signal 207. Thereafter, the processing illustrated in the flowchart in FIG. 7 is ended.

Through the above-described processing, the plurality of digital cameras 101 can execute image capturing at the synchronized time. Because the digital camera 101a operates as a time synchronization source for the time synchronization, the main clock unit 302 ticks time in a free-run state. For this reason, time correction is not executed in step S703 and subsequent steps. Accordingly, the processing in step S704 may be skipped.

FIG. 8 is a flowchart illustrating a processing method executed by the sub-clock unit 303 in FIG. 3. Operations executed by the sub-clock unit 303 are described with reference to FIG. 8. The processing illustrated in the flowchart in FIG. 8 is started every time a rising edge occurs in the operation clock 230 input to the follow-up control unit 304 in a state where a reset state of the follow-up control unit 304 is cancelled. The sub-clock unit 303 executes the operations until the end of the processing in FIG. 8 in 1 cycle of the operation clock 230.

In step S802, the sub-clock unit 303 determines whether the follow-up function setting is set to 1. In a case where the follow-up function setting is set to 1 (YES in step S802) the processing proceeds to step S804. In a case where the follow-up function setting is set to 0 (NO in step S802), the processing proceeds to step S803.

In step S803, the sub-clock unit 303 updates the sub-clock unit time 308 with time acquired by adding the main clock unit additional value 307 to the main clock unit time 306, and ends the processing illustrated in the flowchart in FIG. 8.

In step S804, the sub-clock unit 303 updates the sub-clock unit time 308 with time acquired by adding the sub-clock unit additional value 309 to the sub-clock unit time 308 as the current time, and ends the processing illustrated in the flowchart in FIG. 8.

Through the above-described processing, the sub-clock unit 303 changes the update method of the sub-clock unit time 308 depending on the value of the follow-up function setting. Until the follow-up function setting is changed to 1 from 0 through the processing in FIG. 7, the sub-clock unit 303 executes the time update operation similar to the operation executed when the time of the main clock unit 302 is not corrected. Then, after the follow-up function setting is changed to 1, the sub-clock unit 303 uses the sub-clock unit additional value 309 output from the follow-up control unit 304.

The main clock unit 302 includes a counter unit for upward counting of the main clock unit time 306 by adding the main clock unit additional value 307 to the main clock unit time 306. This main clock unit time 306 is corrected by the time synchronization processing using PTP.

The sub-clock unit 303 includes a counter unit for upward counting of the sub-clock unit time 308 by adding the sub-clock unit additional value 309 to the sub-clock unit time 308 through the processing in step S804.

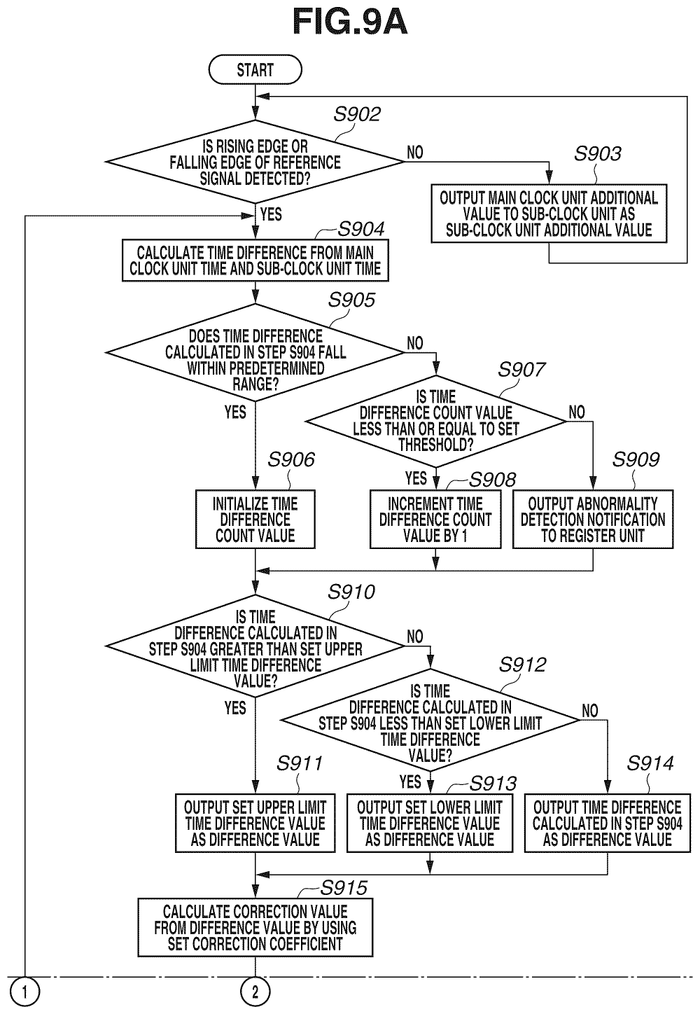

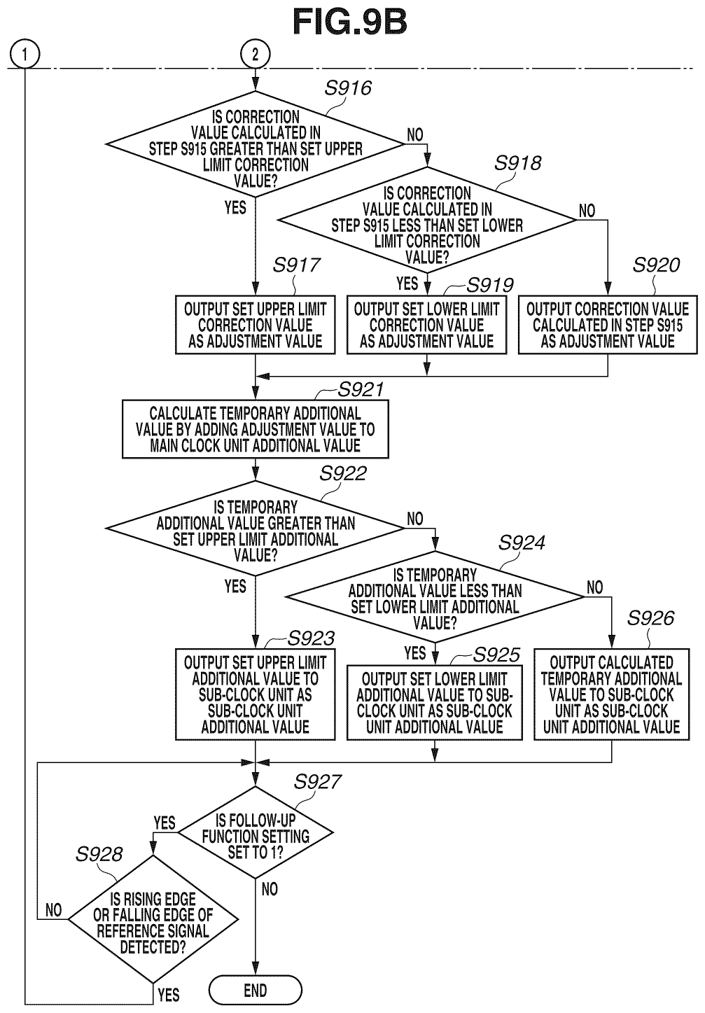

FIGS. 9A and 9B are a flowchart illustrating a processing method executed by the follow-up control unit 304 in FIG. 4. Operations executed by the follow-up control unit 304 are described with reference to FIGS. 9A and 9B. The processing illustrated in the flowchart in FIGS. 9A and 9B is started when the CPU 201 sets the follow-up function setting to 1 in a state where a reset state of the follow-up control unit 304 is cancelled. A time difference count value described in the flowchart in FIGS. 9A and 9B is brought back to an initial value every time the processing illustrated in FIGS. 9A and 9B is started.

In step S902, the start instruction unit 406 determines whether a rising edge or a falling edge of the reference signal 207 is detected. In a case where a rising edge or a falling edge is detected (YES in step S902), the processing proceeds to step S904. In a case where neither a rising edge nor a falling edge is detected (NO in step S902), the processing proceeds to step S903.

In step S903, the switching unit 405 outputs the main clock unit additional value 307 to the sub-clock unit 303 as the sub-clock unit additional value 309. Then, the processing returns to step S902. With this processing, after the follow-up function setting is set to 1, the main clock unit 302 and the sub-clock unit 303 continuously update time by using the same additional value until the first edge occurs in the reference signal 207. As long as the time of the main clock unit 302 is corrected by PTP by controlling the main clock unit additional value 307, a time difference between the main clock unit 302 and the sub-clock unit 303 is not increased.

In step S904, the time difference calculation unit 401 calculates a time difference between the main clock unit time 306 and the sub-clock unit time 308. Then, the processing proceeds to step S905.

In step S905, the time difference calculation unit 401 determines whether the time difference calculated in step S904 falls within a predetermined range. In a case where the time difference falls within a predetermined range (YES in step S905), the processing proceeds to step S906. In a case where the time difference does not fall within the predetermined range (NO in step S905), the processing proceeds to step S907. The predetermined range is set by the register unit 301.

In step S906, the time difference calculation unit 401 initializes the time difference count value. Then, the processing proceeds to step S910.

In step S907, the time difference calculation unit 401 determines whether the time difference count value is less than or equal to a set threshold. In a case where the time difference count value is less than or equal to the threshold (YES in step S907), the processing proceeds to step S908. In a case where the time difference count value is greater than the threshold (NO in step S907), the processing proceeds to step S909. The threshold is set by the register unit 301.

In step S908, the time difference calculation unit 401 increments the time difference count value by 1. Then, the processing proceeds to step S910.

In step S909, the time difference calculation unit 401 outputs the abnormality detection notification 310 to the register unit 301. Then, the processing proceeds to step S910. In other words, the time difference calculation unit 401 outputs the abnormality detection notification 310 in a case where the time difference does not fall within the predetermined range a predetermined number of times consecutively in step S905.

In step S910, the time difference calculation unit 401 determines whether the time difference calculated in step S904 is greater than the set upper limit time difference value. In a case where the time difference is greater than the upper limit time difference value (YES in step S910), the processing proceeds to step S911. In a case where the time difference is less than or equal to the upper limit time difference value (NO in step S910), the processing proceeds to step S912. The upper limit time difference value is set by the register unit 301.

In step S911, the time difference calculation unit 401 outputs the set upper limit time difference value as a difference value 407. Then, the processing proceeds to step S915.

In step S912, the time difference calculation unit 401 determines whether the time difference calculated in step S904 is less than or equal to the set lower limit time difference value. In a case where the time difference is less than or equal to the lower limit time difference value (YES in step S912), the processing proceeds to step S913. In a case where the time difference is greater than or equal to the lower limit time difference value (NO in step S912), the processing proceeds to step S914. The lower limit time difference value is set by the register unit 301.

In step S913, the time difference calculation unit 401 outputs the set lower limit time difference value as a difference value 407. Then, the processing proceeds to step S915.

In step S914, the time difference calculation unit 401 outputs the time difference calculated in step S904 as a difference value 407. Then, the processing proceeds to step S915.

In step S915, the adjustment value calculation unit 402 calculates a correction value from the difference value 407 by using the set correction coefficient. Then, the processing proceeds to step S916. An example of the correction value calculation method is described above, so that descriptions thereof are omitted.

In step S916, the adjustment value calculation unit 402 determines whether the correction value calculated in step S915 is greater than the set upper limit correction value. In a case where the correction value is greater than the upper limit correction value (YES in step S916), the processing proceeds to step S917. In a case where the correction value is less than or equal to the upper limit correction value (NO in step S916), the processing proceeds to step S918. The upper limit correction value is set by the register unit 301.

In step S917, the adjustment value calculation unit 402 outputs the set upper limit correction value as an adjustment value 408. Then, the processing proceeds to step S921.

In step S918, the adjustment value calculation unit 402 determines whether the correction value calculated in step S915 is less than the set lower limit correction value. In a case where the correction value is less than the lower limit correction value (YES in step S918), the processing proceeds to step S919. In a case where the correction value is greater than or equal to the lower limit correction value (NO in step S918), the processing proceeds to step S920. The lower limit correction value is set by the register unit 301.

In step S919, the adjustment value calculation unit 402 outputs the set lower limit correction value as an adjustment value 408. Then, the processing proceeds to step S921.

In step S920, the adjustment value calculation unit 402 outputs the correction value calculated in step S915 as an adjustment value 408. Then, the processing proceeds to step S921.

In step S921, the temporary additional value calculation unit 403 outputs a value acquired by adding the adjustment value 408 to the main clock unit additional value 307 as a temporary additional value 409. Then, the processing proceeds to step S922.

In step S922, the limiting unit 404 determines whether the temporary additional value 409 is greater than the set upper limit additional value. In a case where the temporary additional value 409 is greater than the upper limit additional value (YES in step S922), the processing proceeds to step S923. In a case where the temporary additional value 409 is less than or equal to the upper limit additional value (NO in step S922), the processing proceeds to step S924. The upper limit additional value is set by the register unit 301.

In step S923, the limiting unit 404 outputs the set upper limit additional value as a limit value 410, and the switching unit 405 outputs the limit value (upper limit additional value) 410 to the sub-clock unit 303 as the sub-clock unit additional value 309. Then, the processing proceeds to step S927.

In step S924, the limiting unit 404 determines whether the temporary additional value 409 is less than or equal to the set lower limit additional value. In a case where the temporary additional value 409 is less than or equal to the lower limit additional value (YES in step S924), the processing proceeds to step S925. In a case where the temporary additional value 409 is greater than or equal to the lower limit additional value (NO in step S924), the processing proceeds to step S926. The lower limit additional value is set by the register unit 301.

In step S925, the limiting unit 404 outputs the set lower limit additional value as a limit value 410, and the switching unit 405 outputs the limit value (lower limit additional value) 410 to the sub-clock unit 303 as the sub-clock unit additional value 309. Then, the processing proceeds to step S927.

In step S926, the limiting unit 404 outputs the calculated temporary additional value 409 as a limit value 410, and the switching unit 405 outputs the limit value 410 (temporary additional value 409) to the sub-clock unit 303 as the sub-clock unit additional value 309. Then, the processing proceeds to step S927.

In step S927, the follow-up control unit 304 determines whether the follow-up function setting is set to 1. In a case where the follow-up function setting is set to 1 (YES in step S927) the processing proceeds to step S928. In a case where the follow-up function setting is set to 0 (NO in step S927), the processing illustrated in the flowchart in FIGS. 9A and 9B is ended.

In step S928, the start instruction unit 406 determines whether a rising edge or a falling edge of the reference signal 207 is detected. In a case where a rising edge or a falling edge is detected (YES in step S928), the processing returns to step S904. In a case where neither a rising edge nor a falling edge is detected (NO in step S928), the processing returns to step S927.

Through the above-described processing, the follow-up control unit 304 limits the sub-clock unit additional value 309 to a specified range, and adjusts a speed for increasing time while making the time of the sub-clock unit 303 follow the time of the main clock unit 302 by outputting the sub-clock unit additional value 309. The time difference calculation unit 401 and the adjustment value calculation unit 402 within the follow-up control unit 304 determine whether the calculated values fall within the predetermined ranges, and calculate the difference value 407 and the adjustment value 408, respectively. Through the above processing, it is also possible to limit a speed for making the time of the sub-clock unit 303 become closer to the time of the main clock unit 302.

FIG. 10 is a flowchart illustrating a processing method executed by the signal generation unit 305 in FIG. 3. Operations executed by the signal generation unit 305 are described with reference to FIG. 10. The processing illustrated in the flowchart in FIG. 10 is started when start time is notified by the instruction for starting output of the reference signal 207 in a state where a reset state of the follow-up control unit 304 is cancelled. When the processing in FIG. 10 is started, the reference signal 207 is always started at 0. Then, the instruction for starting output of the reference signal 207 includes information about a cycle of the reference signal 207, and specifies a frequency of the reference signal 207 to be generated.

In step S1002, the signal generation unit 305 determines whether the sub-clock unit time 308 has reached the specified time (start time). In a case where the sub-clock unit time 308 has reached the specified time (YES in step S1002), the processing proceeds to step S1003. In a case where the sub-clock unit time 308 has not reached the specified time (NO in step S1002), the processing proceeds to step S1004.

In step S1003, the signal generation unit 305 outputs the reference signal 207 at 1. Then, the processing proceeds to step S1005.

In step S1004, the signal generation unit 305 determines whether a reference signal stop instruction is received. In a case where the reference signal stop instruction is received (YES in step S1004), the processing proceeds to step S1009. In a case where the reference signal stop instruction is not received (NO in step S1004), the processing returns to step S1002.

In step S1005, the signal generation unit 305 updates the reference signal inversion time. Then, the processing proceeds to step S1006. In a case where the reference signal 207 is controlled through the processing in step S1003 after the processing in step S1002, the signal generation unit 305 updates the reference signal inversion time with time acquired by adding the half cycle of the reference signal 207 (the half cycle is 500 ms when the reference signal 207 is 1 Hz) to the specified time (start time). In a case where the reference signal 207 is controlled through the processing in step S1007 after the processing in step S1006, the signal generation unit 305 updates the reference signal inversion time by adding the half cycle to that reference signal inversion time.

In step S1006, the signal generation unit 305 determines whether the sub-clock unit time 308 has reached the reference signal inversion time. In a case where the sub-clock unit time 308 has reached the reference signal inversion time (YES in step S1006), the processing proceeds to step S1007. In a case where the sub-clock unit time 308 has not reached the reference signal inversion time (NO in step S1006), the processing proceeds to step S1008.

In step S1007, the signal generation unit 305 inverts and outputs the reference signal 207. Then, the processing returns to step S1005.

In step S1008, the signal generation unit 305 determines whether a reference signal stop instruction is received. In a case where the reference signal stop instruction is received (YES in step S1008), the processing proceeds to step S1009. In a case where the reference signal stop instruction is not received (NO in step S1008), the processing returns to step S1006.

In step S1009, the signal generation unit 305 outputs the reference signal 207 at 0, and ends the processing illustrated in the flowchart in FIG. 10.

In the first exemplary embodiment, the temporary additional value calculation unit 403 uses the main clock unit additional value 307 to execute calculation. In the second exemplary embodiment, the temporary additional value calculation unit 403 uses the sub-clock unit additional value 309. The temporary additional value calculation unit 403 outputs a value acquired by adding the adjustment value 408 to the sub-clock unit additional value 309 as the temporary additional value 409. In a case where the same correction coefficient is used, time taken to make the sub-clock unit time 308 reach the main clock unit time 306 tends to be longer in the second exemplary embodiment than in the first exemplary embodiment.

This is because the adjustment value 408 is added to the main clock unit additional value 307 in the first exemplary embodiment. Therefore, as long as the limit value 410 output from the limiting unit 404 falls within the set range, a time difference certainly be reduced when the sub-clock unit additional value 309 calculated at the first rising edge of the reference signal 207 is used.

On the other hand, in the second exemplary embodiment, in a case where the sub-clock unit additional value 309 is used, a correction value is added thereto as the adjustment value 408. In this case, the sub-clock unit additional value 309 does not always reach a value less than/greater than the main clock unit additional value 307. In this case, the sub-clock unit additional value 309 is calculated again a plurality of times when the rising edge or the falling edge occurs in the reference signal 207, so that the time difference is to be reduced. The second exemplary embodiment is adopted in a case where the main clock unit additional value 307 cannot be referred.

In the first exemplary embodiment, the time difference calculation unit 401 simultaneously compares the main clock unit time 306 and the sub-clock unit time 308 to calculate a time difference. In a third exemplary embodiment, in a case where the main clock unit time 306 cannot be acquired simultaneously with the acquisition of the sub-clock unit time 308, the time difference calculation unit 401 calculates a time difference between the sub-clock unit time 308 and an estimated value of the main clock unit time 306.

Issues to be solved by the first to the third exemplary embodiments are described below. In a case where the digital cameras 101 execute time synchronization on a wireless network by using PTP, fluctuations caused by wireless communication may occur in the transmission of PTP packets. In this case, network delay time between the digital cameras 101 is fluctuated, so that time synchronization accuracy of the main clock unit 302 is lowered. In a case where the signal generation unit 305 generates the reference signal 207 by using the main clock unit time 306 of the main clock unit 302 with poor synchronization accuracy, fluctuations of the main clock unit time 306 appear in jitters of the reference signal 207. Accordingly, there is an issue that synchronized image capturing operations become unstable because the image capturing unit 205 executes image capturing by detecting a rising edge and a falling edge of the reference signal 207.

Effects of the first to the third exemplary embodiments are described below. The sub-clock unit time 308 of the sub-clock unit 303 moderately follows the main clock unit time 306 of the main clock unit 302. The signal generation unit 305 generates the reference signal 207 based on the sub-clock unit time 308, so that it is possible to suppress jitters and rapid change of the reference signal 207. Accordingly, the synchronized image capturing operations executed by the image capturing unit 205 become stable.

The present disclosure can be realized through processing in which a program for implementing one or more functions according to the above-described exemplary embodiments is supplied to a system or an apparatus via a network or a storage medium, so that one or more processors within a computer included in the system or the apparatus read and execute the program. Further, the present disclosure can also be realized with a circuit (e.g., application specific integrated circuit (ASIC)) which implements one or more functions.

The above-described exemplary embodiments are merely the examples for implementing the present disclosure, and shall not be construed as limiting a technical range of the present disclosure. In other words, the present disclosure can be implemented in diverse ways without departing from a technical spirit or a main feature of the present disclosure.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., an ASIC) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., a CPU, micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray™ Disc (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the priority to and benefit of Japanese Patent Application No. 2024-075970, filed May 8, 2024, the entirety of which is incorporated herein by reference.

What is claimed is:

1. A communication apparatus comprising:
a first counter unit configured to count a first time;
a second counter unit configured to count a second time;
a first calculation unit configured to calculate a difference between the first time and the second time;
a second calculation unit configured to calculate a first additional value based on the difference; and
a limiting unit configured to assign a first upper limit to a second additional value in a case where the first additional value is greater than the first upper limit, assign a first lower limit to the second additional value in a case where the first additional value is less than the first lower limit, and assign the first additional value to the second additional value in other cases,
wherein the second counter unit counts the second time by adding the second additional value to the second time.

2. The communication apparatus according to claim 1, further comprising a signal generation unit configured to generate a signal having a predetermined cycle based on the second time.

3. The communication apparatus according to claim 2, wherein the first calculation unit is further configured to calculate a difference between the first time and the second time upon detection of at least one of a rising edge or a falling edge of the signal generated by the signal generation unit.

4. The communication apparatus according to claim 2, further comprising an image capturing unit configured to capture an image based on the signal generated by the signal generation unit.

5. The communication apparatus according to claim 1, wherein the first calculation unit is further configured to calculate a difference between an estimated value of the first time and the second time.

6. The communication apparatus according to claim 1, wherein the second calculation unit is further configured to assign a value acquired by adding the adjustment value based on a difference between the second additional value and the first additional value.

7. The communication apparatus according to claim 1,
wherein the first counter unit is further configured to count the first time by adding a third additional value to the first time, and
wherein the second calculation unit is further configured to assign a value acquired by adding an adjustment value based on a time difference between the third additional value and the first additional value.

8. The communication apparatus according to claim 7, wherein the first time is corrected by time synchronization processing, and the apparatus further comprises a third calculation unit configured to calculate the adjustment value based on the time difference and a correction coefficient.

9. The communication apparatus according to claim 8, wherein the third calculation unit is further configured to calculate a correction value based on the time difference and the correction coefficient, assign a second upper limit value to the adjustment value in a case where the correction value is greater than the second upper limit value, assign a second lower limit to the adjustment value in a case where the correction value is less than the second lower limit, and assign the correction value to the adjustment value in other cases.

10. The communication apparatus according to claim 8,
wherein the first calculation unit is further configured to assign a third upper limit to a difference value in a case where the time difference is greater than the third upper limit, assign a third lower limit to the difference value in a case where the time difference is less than the third lower limit, and assign the time difference to the difference value in other cases, and
wherein the third calculation unit is further configured to calculate the adjustment value based on the difference value and the correction coefficient.

11. The communication apparatus according to claim 1, wherein the first calculation unit is further configured to output a notification in a case where the difference does not fall within a predetermined range for a predetermined consecutive number of times.

12. A processing method of a communication apparatus including a first counter unit configured to count a first time, the first time being corrected by time synchronization processing, and a second counter unit configured to count a second time, the processing method comprising:
calculating a difference between the first time and the second time;
calculating a first additional value based on the difference;
assigning a first upper limit to a second additional value in a case where the first additional value is greater than the first upper limit;
assigning a first lower limit to the second additional value in a case where the first additional value is less than the first lower limit; and
assigning the first additional value to the second additional value in other cases, wherein the second time is counted by adding the second additional value to the second time.

13. A non-transitory storage medium storing a program causing a communication apparatus including a first counter unit configured to count a first time, the first time being corrected by time synchronization processing, and a second counter unit configured to count a second time to execute a processing method, the processing method comprising:
calculating a difference between the first time and the second time;
calculating a first additional value based on the difference;
assigning a first upper limit to a second additional value in a case where the first additional value is greater than the first upper limit;
assigning a first lower limit to the second additional value in a case where the first additional value is less than the first lower limit; and
assigning the first additional value to the second additional value in other cases,
wherein the second time is counted by adding the second additional value to the second time.
